(19) United States
(12) Patent Application Publication
(10) Pub. No.: US 2017/0348614 A1
(43) Pub. Date: Dec. 7, 2017

(54) METHOD FOR SEPARATING LIQUIDS AND USE THEREOF

(71) Applicant: Karlsruher Institut fuer Technologie, Karlsruhe (DE)

(72) Inventors: Claudia Zeiger, Karlsruhe (DE); Hendrik Hoelscher, Weingarten (DE); Matthias Worgull, Stutensee (DE); Maryna Kavalenka, Karlsruhe (DE)

(21) Appl. No.: 15/536,662

(22) PCT Filed: Dec. 18, 2015
(86) PCT No.: PCT/EP2015/002554

§ 371 Date: Jun. 16, 2017

(30) Foreign Application Priority Data
Dec. 19, 2014 (DE) 10 2014 119 183.8

(51) Int. Cl. B01D 17/02; B01J 20/34; B01D 15/32; C02F 1/40; C02F 1/28; E02B 15/10; C02F 101/32

(52) U.S. Cl. CPC B01D 17/0202; C02F 1/40; B01J 20/345; C02F 1/285; B01D 15/327; C02F 2101/32; E02B 15/103; E02B 15/104

(57) ABSTRACT

A molded body includes a shape memory material. The molded body has a three-dimensional surface structure which, in a permanent shape, at least in part has a superhydrophobic surface and/or a hydrophobic surface, on which water droplet contact angles of 120° to 150° are found.

### CROSS REFERENCE TO RELATED APPLICATIONS

This application is a U.S. National Stage application under 35 U.S.C. §371 of International Application No. PCT/EP2015/002554 filed on Dec. 18, 2015, and claims benefit to German Patent Application No. DE 10 2014 119 183.8 filed on Dec. 19, 2014. The International application was published in German on Jun. 23, 2016 as WO 2016/096142 A1 under PCT Article 21(2).

### FIELD

The invention relates to a method for separating a liquid from a molded body and to the use thereof for multiple separation of liquids and for continuous separation of a liquid from a molded body.

### BACKGROUND

As a result of disasters such as the explosion on the Deepwater Horizon oil platform in 2010, but also as a result of industrial effluent containing oil, incorrect disposal of used oil or leaking tanks, ever increasing and vast quantities of oil are being released into the environment, where they cause lasting large-scale damage. Conventional methods for combating oil pollution include the use of chemical dispersants and the controlled burning of the oil. However, both methods only shift the problem elsewhere in the first instance, as they lead to additional environmental hazards.

The method of choice is therefore skimming off the oil floating on the water surface at an early stage in the proceedings. To make oil skimming more efficient, absorbents, such as sawdust, rice straw or cotton wool are used. However, the major disadvantage of such sorbents is that they also absorb a considerable volume of water in addition to the oil. This lack of selectivity requires the subsequent separation of oil and the water absorbed unintentionally. Separating the oil from the sorbents used ranges from a complex process to completely impossible.

This disadvantage has been resolved by manufacturing sorbents that ensure selective oil absorption. In Korhonen et al. Hydrophobic nanocellulose aerogels as floating, sustainable, reusable and recyclable oil absorbents, ACS Appl. Mater. Interfaces, 3, p. 1813, 2011, Korhonen et al. describe aerogels that selectively absorb non-polar liquids and oil from water. DE 10 2013 109 621 A1 describes a method for producing a molded body having superhydrophobic surfaces for selective absorption of a non-polar liquid.

In a first step, the auxiliary agent is distributed on the surface of the contaminated water, where it absorbs the oil on a more or less selective basis. In a second step, the sorbents are skimmed from the surface of the water with the oil so that the subsequent separation process, reprocessing or thermal recycling can take place in a third step. The major disadvantage of these sorbents is that they cannot be used more than once and thus cause huge quantities of waste. It would only be possible to reuse them by complex reprocessing or by creating additional quantities of waste. There is also a risk that the sorbents will not be able to be fully removed from the water afterwards, thus introducing environmentally harmful material into the environment. A further significant disadvantage of these possible means of cleaning up polluted water lies in their sequential nature, which is particularly disadvantageous in the case of large oil volumes.

The molded body described in DE 10 2013 109 621 A1 does not solve the problem of separating oil and polymers and does not ensure that the oil can be recovered. As the molded body cannot be used more than once, large quantities of waste are produced. As it was not possible to separate the oil from the polymer surface, the polymer has to be disposed of together with the oil in a complex process.

Continuous processes for removing oil from water contaminated with oil use oil skimmers, also known as surface suction skimmers.

Weir skimmers use exclusively the density difference between oil and water. The oil floating on the water surface flows over an edge floating just under the water surface into a container and is then pumped out. See http://www.hydrotechnik-luebeck.de/olseparation/oelskimmer-ausruestung-fuer-die-oelwehr/. The disadvantage of these skimmers is their lack of selectivity, which means that large quantities of water are pumped out with the oil, especially with low oil volumes or thin oil films on the water surface.

Adhesion skimmers (tube/belt/disc skimmers) have a surface (tube/belt/disc) that moves through the water. The oil adheres to the surface and is removed via a collection tank. See http://www.hydrotechnik-luebeck.de/olseparation/oelskimmer-ausruestung-fuer-die-oelwehr/. See also M. Friess http://www.thonke-iv.de/Wasser.pdf. The available belt, tube or disc skimmers are suitable for cleaning up cooling lubricants. However, their cleaning capacity (approx. 5 to 251/h) is too low for removing oil pollution from rivers or lakes. In addition, the way they operate means that they can only be used on calm waters. Furthermore, the thickness of the oil layer for which these skimmers are suitable is subject to a lower limit. If the oil layer is too thin, large quantities of water will be removed too. See M. Friess http://www.thonke-iv.de/Wasser.pdf.

In the case of larger oil/water quantities, oil is removed from the water surface by means of oil-adhesive drums and separated from the drums by scraping. See http://www.raw-international.com/produkte-loesungen/sortiment/oel-skimmer/trommelskimmer.html. As the oil taken up by the drum skimmer is scraped off from the surface, only smooth surfaces can be used for this purpose. The residual water content already achieved with drum skimmers is 2%. See http://www.raw-international.com/produkte-loesungen/sortiment/oel-skimmer/trommelskimmer.html.

### SUMMARY

In an embodiment, the present invention provides a molded body that includes a shape memory material, wherein the molded body has a three-dimensional surface structure which, in a permanent shape, at least in part has a superhydrophobic surface and/or a hydrophobic surface, on which water droplet contact angles of 120° to 150° are to be found.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a flow diagram for a method according to an embodiment of the invention;

FIG. 2 shows a first embodiment of a continuous process for separating liquids;

FIG. 3 shows a second embodiment of a continuous process for separating liquids; and

FIG. 4 illustrates water contact angle measurements on the surfaces of five molded bodies which have passed through method steps according to an embodiment of the invention, and in particular, the flat pressing and surface structure resetting method steps.

### DETAILED DESCRIPTION

A method is described herein for separating at least one liquid and a molded body which does not demonstrate the restrictions and disadvantages of the prior art.

In particular, a method is described herein which allows the molded body to be reused and provides a continuous process for separating liquids.

A molded body is described herein that at least in part comprises a shape memory material, wherein the molded body has a three-dimensional surface structure, which, in a permanent shape, at least in part (has) a superhydrophobic surface and/or a hydrophobic surface, on which water droplet contact angles of 120° to 150° are to be found.

In a particular embodiment of the invention, the surfaces are hydrophobic surfaces on which water droplet contact angles of 140° to 150° are to be found.

In a further embodiment, in a temporary shape, the molded body at least in part has a superhydrophilic surface and/or a hydrophilic surface on which water droplet contact angles of less than 90° are to be found.

A method is described herein for separating at least one liquid from a molded body wherein the method includes, in a first method step a), a molded body at least in part comprising a shape memory material is provided, wherein the molded body has a three-dimensional surface structure which, in a permanent shape, at least in part has a hydrophobic and/or a superhydrophobic surface. In the second method step b), the molded body is brought into contact with at least one liquid or with a mixture of a plurality of liquids, wherein at least one liquid will selectively adhere to the molded body. In a further method step c), the surface structure is transformed into a temporary shape by means of flat pressing, wherein the surface which is hydrophobic and/or superhydrophobic at least in part is minimized. As a result, the at least one liquid no longer adheres to the surface of the molded body. In method step d), the at least one liquid is then removed and the surface structure is returned to the permanent shape in the next method step e).

A surface is described as superhydrophilic if it can be completely wetted with water, wherein the spreading parameter is S>0. Similarly, a superlipophilic material is sufficiently lipophilic or has such as affinity for oil that the oil is distributed fully over the surface until it is completely wetted with at least one monolayer. An extremely hydrophobic surface is defined as being superhydrophobic if it can be very heavily wetted, i.e. in which the corresponding water droplet contact angle is greater than 150°.

With regard to wettability with water, surfaces are subdivided into four groups: surfaces which are completely wetted with water, or on which contact angles of less than 10° are to be found, are described as superhydrophilic; surfaces with water droplet contact angles of more than 10° but less than 90° are described as hydrophilic; if the contact angle is 90° or more, the surface is described as hydrophobic; with very large contact angles in excess of 150°, the surfaces are described as superhydrophobic.

Due to the typical material properties of the polymers used, these are also lipophilic or oleophilic. Oil preferably forms a contact angle of less than 90°. These properties are enhanced by the three-dimensional surface structure and the surfaces become superlipophilic or superoleophilic, i.e. oil forms contact angles of preferably less than 10°.

In a particular embodiment, the molded body is formed by a shape memory material or is coated with such a material. The return of the shape memory material to its original shape thus causes the surface structure to return directly to the permanent shape. Alternatively, the shape memory material forms the support structure for a coating or the shape memory polymer permeates the molded body. In such cases, it ensured that the surface structure returns to its original shape indirectly via resetting of the support structure. The coating material and the remaining material of the molded body are preferably resilient.

A roller or rolling device is preferably used for flat pressing.

In a particular embodiment, the surface structure is a crater structure wherein tiny polymer hairs are preferably formed on the upper edges of the craters. The tiny hairs increase the absorption selectivity of the at least one liquid compared to other liquids.

The craters of the molded body preferably have an average diameter of 2 μm to 250 μm and a height of 1 μm to 500 μm, with tiny polymer hairs having a length of 0.5 μm to 200 μm on their upper edges.

According to a further preferred embodiment of the present invention, the shape memory material is selected from the group consisting of polymers, metal alloys, ceramics and gels. Suitable shape memory materials include, but are not restricted to, shape memory alloys (SMA), shape memory polymers (SMP), electroactive polymers (EAP), ferromagnetic SMA, magnetic SMA, electrorheological fluids (ER), magnetorheoligical fluids (MR), dielectric elastomers, ionic polymer-metal composites (IPMC), piezoelectric materials, piezoceramic materials, and different combinations of the above-mentioned materials. In addition, combinations of the above-mentioned materials can be used to achieve results which would not be possible with a single material. For example, an SMP can be controlled by heat, whereas a piezoceramic material can be controlled by electrical means. Different actuators can therefore control a molding insert in different directions.

In a particular embodiment, the shape memory material is an elastomer which goes back to its permanent shape of its own accord, or in other words without any external stimulus, after temporary deformation, a shape memory polymer or a thermoplastic polymer. The elastomers must have corresponding wetting properties and adequate resilience. The elastomer is preferably UV or chemically crosslinked. The shape memory polymer is preferably activated by light or by magnetic means, and particularly preferably by heat. Magnetic activation is achieved indirectly by heating magnetic particles. The molded body is preferably a sheet.

According to a particularly preferred embodiment, the shape memory material is a heat-activated shape memory polymer. Shape memory polymers (SMP) having a transition to the glass state in the rubber-elastic range offer the option to program various states as a function of temperature (permanent shape when T>T_{g}; temporary shape when T_{g}>T>Tₜᵣₐₙₛ). In this case, T_{g} corresponds to the glass transition temperature and Tₜᵣₐₙₛ corresponds to the transformation temperature. Suitable shape memory polymers may include thermoplastic, thermosetting, interpenetrating networks. Examples of suitable polymer components include, but are by no means restricted to, polyphosphazenes, polyvinyl alcohols, polyamines, polyesteramides, polyamino acids, polycarbonates, polyanhydrides, polyacrylates, polyalkylene glycols, polyalkylene terephthalates, polyalkylene oxides, polyorthoesters, polyvinyl ethers, polyvinyl esters, polyvinyl halogenides, polyesters, polyactides, polyglycolides, polysiloxanes, polyurethanes, polyethers, polyetheramides, polyetheresters, copolymers and combinations thereof. Persons skilled in the art are able to produce shape memory polymers with the required properties from these components by using known chemical principles and processing techniques without excessive experimentation. Examples of suitable and commercially available heat-activated shape memory polymers include Tecoflex® and TecoPlast®.

In a further embodiment, the at least one liquid is non-polar, preferably liquid hydrocarbons and particularly preferably oil.

In a particular embodiment, the molded body is applied at least in part to at least one first roller and the surface structure is transformed into a temporary shape by radial pressure in contact at least in part with a second roller during method step c).

Initially, a molded body is preferably produced by hot drawing as a permanent form of a shape memory material. This structured molded body is preferably attached to the first roller, or to a first rolling device. The first and second rollers are preferably unstructured steel rolling devices.

In a further embodiment, the structured molded body is rolled over two first rollers as a belt, the molded body then being pressed flat by a second roller.

In a particular embodiment, it is possible to produce the structured molded body, in other words in its permanent shape, directly on the first roller if an unstructured molded body has been attached to it.

A steel plate structured by means of sand blasting or, if the structure is produced using the roll-to-roll method, a steel roller structured by sand blasting is preferably used as a molding insert in this process.

In a particular embodiment, the first roller having the structured molded body is brought into contact with a second roller using a force that depends on the material and the height and width of the roller, so as to create a roll-to-roll-like device. The first roller covered with the molded body is then immersed in at least one liquid or in a mixture of a plurality of liquids. By rotating the first roller equipped with the molded body, it is possible for the at least one liquid to be selectively absorbed from the mixture. The second roller is in contact with the latter during this operation and rotates in the opposite direction. After the molded body with the at least one liquid has passed the highest point on the first roller, the molded body is pressed flat by the second roller, causing the at least one liquid adsorbed on the molded body to be pressed comprehensively out of said molded body. The device is preferably inclined slightly so that the at least one liquid can be discharged in a specific direction, and thus collected in a targeted manner.

In a particular embodiment, it is possible for the at least one liquid to be collected above the roller contact point by extraction. The flat-pressed elastomer, which is thus relieved of the at least one liquid, automatically returns to the permanent structured shape as soon as the force of the second roller is no longer applied. In contrast, the shape memory polymer is heated, preferably by warm air, before being immersed again in the mixture, causing the permanent shape of the shape memory polymer to be restored and thus ensuring that it can be re-used. This is thus a continuous process.

The molded body is preferably produced using the method in DE 10 2013 109 621 A1, wherein it comprises a superhydrophobic surface made from a polymer which can be obtained via a specially designed forming method. The polymer used may itself be originally hydrophilic or hydrophobic. The surface of the molded body preferably has a crater structure having craters with an average diameter of 2 μm to 250 μm and a height of 1 μm to 500 μm, on the upper edges of which tiny polymer hairs are formed measuring 0.5 μm to 200 μm in length.

In a first embodiment, the length of the tiny polymer hairs corresponds to 0.5 times to 10 times the average diameter of the craters. As shown in the tests performed, these structures have a substantially fully water-repellent nature and their geometric form reproduces the lotus effect. By hot-drawing structured polymer sheets, the surfaces produced are both superlipophilic and superhydrophobic and selectively adsorb non-polar liquids such as oil, while simultaneously repelling polar liquids such as water.

In a second embodiment, the length of the tiny polymer hairs corresponds to 0.01 times to 0.5 times the average diameter of the craters. As shown in the tests performed, these structures do not allow any adhesion or allow a high level of adhesion on the surface of the molded body, especially for polar liquids such as water, as a function of the density of the craters along with the density of the tiny polymer hairs situated on the upper edge of the craters. If this function is selected appropriately, the structures formed on the surface of the molded body are able to capture water droplets.

The molded body can preferably be obtained by a method comprising method steps A) to D).

In a particular embodiment, an unstructured molded body is first provided between a first plate and a polymer sheet in a first method step A).

In a further embodiment, the molded body also comprises a polymer sheet, in this case understood to be a flat and elongated structure made of a polymer, particularly a thermoplastic polymer (thermoplast), having a thickness of 1 μm to 10 cm, preferably 250 μm to 2 mm.

The composite is preferably produced from the first plate and the molded body by inserting the molded body between the first plate and a second plate in the first instance for this purpose. In practice, one of the two plates (first plate) always has greater adhesion to the polymer, while the other of the two plates (second plate) displays lower adhesion to the polymer, especially if it already has a polished or ground surface, or if a separating layer is inserted between it and the molded body. To produce the composite from the polymer sheet with the first plate which has good adhesion, both plates are then preferably heated to a temperature above the glass transition temperature T_{g} of the polymer contained in the molded body, wherein the softened polymer is pressed onto the first plate by applying a compression force such that the composite is formed from the molded body and the first plate, and the molded body and the backing plate are finally detached from one another.

A third plate is prepared in a second method step B), said third plate having rough areas, which have an average roughness Rₐ′ of 1 μm to 20 μm, preferably 8 μm to 15 μm, and an average roughness depth R_{z} of 30 μm to 100 μm, preferably 40 μm to 50 μm. The required roughness is preferably produced by the effect of particles, preferably by sand blasting, on at least one side of the third plate.

In a third method step C), which represents the actual molding step, the desired structures described above are produced on the surface of the molded body. The third plate acts as a molding insert plate in the forming process and is accordingly placed facing, but not yet touching, the composite comprising the first plate and the molded body produced in method step a). The third plate is then heated to above the glass transition temperature T_{g} of the polymer contained in the molded body, wherein the composite comprising the first plate and the polymer sheet itself is not heated. If the hot third plate now comes into contact with the molded body in its capacity as a molding insert plate and force is applied, the polymer is pressed in part from the molded body into the existing rough areas in the third plate.

In a fourth method step D), which represents the unmolding process, the other surface of the molded body facing the third plate is structured by a relative movement between the first plate comprising the composite and the third plate acting as the molding insert plate provided that the molded body, which forms a composite with the first plate, and is thus covered by the relative movement, still remains soft during the unmolding process, i.e. as long as its temperature roughly corresponds to the glass transition temperature and as a result is able to be elongated. In this process, the direction of the relative movement is substantially anti-parallel to the direction in which force is applied and perpendicular to or at an angle to the mid-surface of the first plate, including the molded body in the composite, and the third plate.

The precise geometric form of the structures in this case is adjusted by appropriate selection of a set of parameters, as will be familiar to a person skilled in the art and include the following: temperature to which the third plate is heated during method step b), roughness of the third plate, amount of force causing the hot third plate to come into contact with the molded body during method step b) in its capacity as a molding insert plate, stay time during which force is applied to the molded body, and unmolding speed, with which the relative movement between the first plate comprising the composite and the third plate acting as a molding insert plate is performed.

Depending on the selected set of parameters, in particular at a temperature below the melting range of the polymer, the pressed polymer sheet is unmolded (drawn) from the third plate while it is still warm, preferably without leaving any residues, causing tiny fine, dense polymer hairs to be drawn, these being arranged in a crater-like structure. These structures are similar to the lotus effect as a result of their geometric form.

If a different set of parameters is selected, in particular if the temperature is in the melting range of the polymer, unmolding the pressed molded body from the third plate while it is still warm causes the polymer layer to be torn away, forming small craters with very tiny polymer hairs on their upper edges. These structures allow a high level of adhesion on the molded polymer layer as a function of the density of the craters along with the density of the tiny polymer hairs on the upper edge of the craters, especially with regard to water.

If yet another set of parameters is selected, in particular if the temperature is between the embodiments described above, the craters formed during unmolding have longer polymer hairs on their upper edges, which in comparison lead to a mid-level of adhesion on the molded polymer layer, especially with regard to water.

In an alternative embodiment, the first plate and/or second plate and/or third plate used in the present method is/are designed as a roller. An embodiment of this type permits a considerably higher throughput during practical implementation of the present method.

To permit a plurality of liquids to be separated in a continuous process, and to avoid unnecessary waste, a surface with a similar structure is preferably produced in the present invention optionally from an elastomer or a shape memory polymer (SMP). Shape memory polymers have the ability to return to a characteristic original, permanent shape after a temporary shape change following a specific stimulus, preferably temperature. Elastomers also go back to their original shape after a temporary shape change, but without the ability to retain their temporary shape for a required period.

This resilience effect is utilized to allow the surface structure to be reused after removing the at least one liquid from the surface.

Methods described herein can be used for multiple separation of liquids. Methods can preferably be used to separate non-polar and polar liquids, wherein the non-polar liquid is selectively absorbed by the molded body and the molded body can be reused after each use. Oil is preferably separated from water by this method.

In a particular embodiment of the invention, a method is used to continuously separate a liquid from a molded body.

A method according to an embodiment of the invention is also used to remove oil from water, to prepare cooling water, to remove oil from cooling water or from water contaminated with oil, to clean up an oil spill or to remove oil from effluents in water treatment plants.

A particular advantage of the present invention is that it permits a continuous process to clean water contaminated with oil in a highly selective and highly efficient manner, and to recover the oil. A characteristic feature is that the structure is then restored, or reforms of its own accord, which means that the structured surface can be reused without chemical treatment. In this case, there is no waste and no environmental risk, and the resources used are reduced to a minimum. The fact that the molded body is attached to a roller or is passed over rollers in the manner of a belt leads to an infinite, continuous process. The molded body is reused in this process, and does not need to be replaced after a single use.

By using selective surface structures, it is also possible to separate different liquids from one another by using different crater structures. The different types of crater structures required for this purpose would be obtained by varying the parameters during production (temperature, times, drawing speed, etc.) and by varying the unstructured molded body (material, thickness, etc.).

The use of a roller to press out the non-polar liquid and simultaneously press the surface structure flat permits the use of surfaces with nanostructures. This makes it possible to achieve a higher output over the same time with the same use of materials (same sized machine) than in traditional skimmer methods, as the structured molded body has a higher absorption capacity per surface area than a smooth surface. It is also possible to achieve even lower residual water content than the residual water content of 2% achieved with drum skimmers due to the superhydrophobic behavior of the structured molded body.

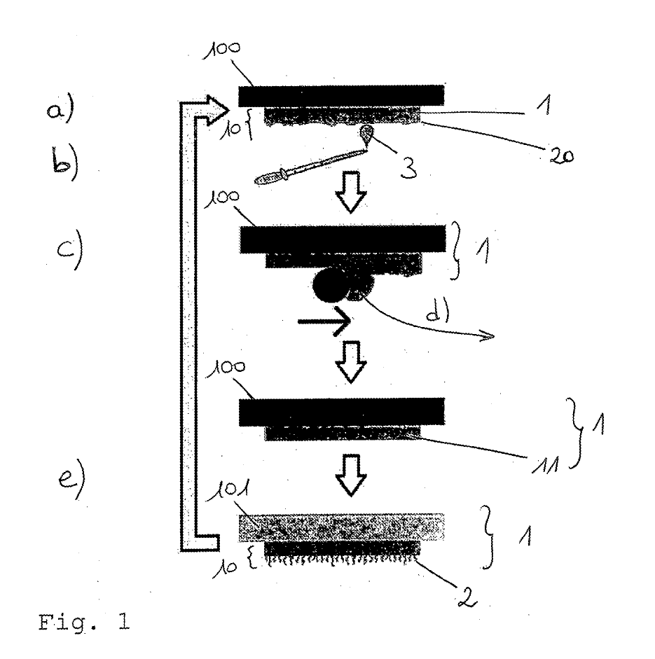

FIG. 1 is a flow diagram for an embodiment of the method according to an embodiment of the invention. FIG. 1a shows method step a), preparing a molded body 1 at least in part comprising a shape memory polymer on a steel plate 100. In this case, the shape memory polymer at least in part comprises a superhydrophobic surface with a surface structure 2 in its permanent shape 10. The molded body 1 is brought into contact with at least one liquid 3 which is selectively absorbed by the molded body 1 (FIG. 1b).

This results in a surface structure 20 which is wetted with liquid. The shape memory material is then pressed flat into its temporary shape 11, as shown in FIG. 1c. The at least one liquid 3 is removed in method step d). Finally, the shape memory polymer is returned to its permanent shape 10, as shown by way of example by heating the above-mentioned steel plate (heated steel plate 101). This restores the surface structure 2, which is then free from liquid. This method can thus be started again, as shown by the arrow.

FIG. 2 shows the principle behind the continuous process for separating liquids. An SMP or elastomer, which is a hot-drawn structured molded body in its permanent shape 10, is located on the first roller 51. This is immersed in a mixture 30, and selectively absorbs at least one liquid in this process. A second roller 52 presses the molded body 1 flat, causing the at least one liquid to be discharged again so that it can be collected. A slight inclination of the device during this operation specifies the direction in which the at least one liquid 3 will be discharged. Alternatively, extraction of the at least one liquid is possible at this point. By then heating the SMP (step e)), which is not necessary in the case of elastomers, the molded body is returned to its permanent shape 10.

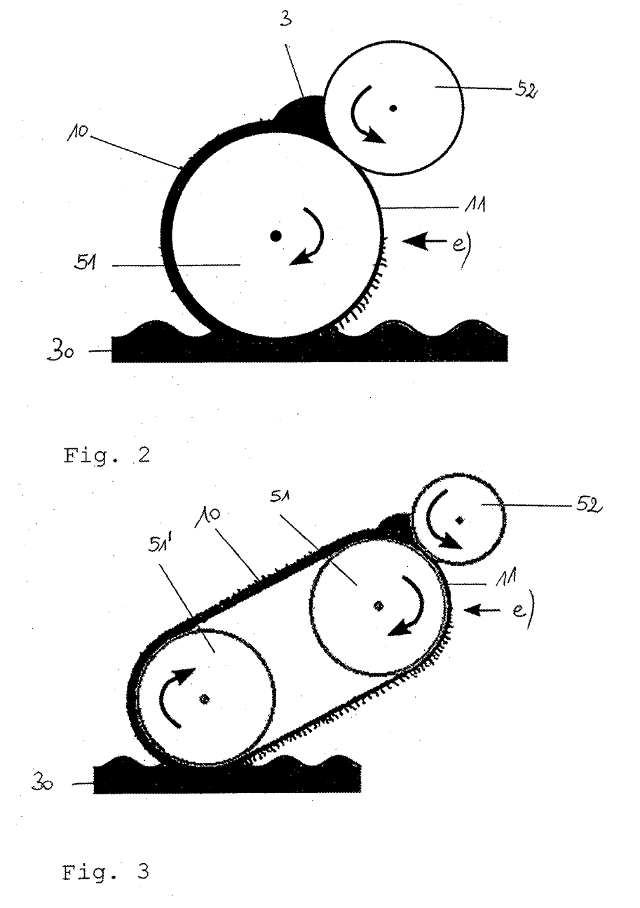

FIG. 3 shows an alternative structure in which the molded body 1 having a nanostructure runs as a belt over two first rollers 51, 51′, the at least one liquid 3 being absorbed from the mixture 30, and is then pressed flat by a second roller 52, during which the molded body 1 assumes its temporary shape 11. As in the structure shown in FIG. 2, the at least one liquid is again pressed out and is able to be discharged or extracted. The molded body 1 is also returned to its permanent shape 10 by using heat in the case of the SMP (step e)), or returns of its own accord in the case of elastomers.

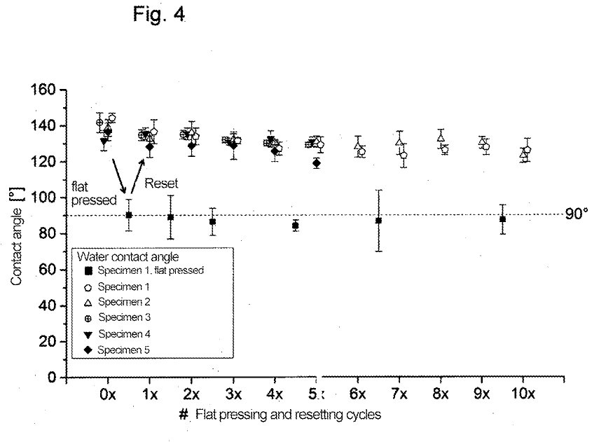

FIG. 4 shows the formation of the water contact angle on five molded bodies, each having a three-dimensional surface structure. These molded bodies pass through the method according to the invention ten times, during which one cycle in particular comprises the following method steps: flat pressing the surface structure and resetting the surface structure. By flat pressing the surface structure of the molded body, it is possible to achieve a flat surface on which water contact angles of less than 90° can be measured and the surface becomes hydrophilic as a result. By resetting, the surfaces are returned to their three-dimensional structure. FIG. 4 shows that the water contact angles remain stable throughout the cycles. The properties of this surface structure with regard to wettability are retained accordingly. In particular, water contact angles of between 120° and 140° can be measured, representing a highly hydrophobic surface. This shows that restoration of the three-dimensional surface structure is also possible after flat pressing on multiple occasions and that reusability of the molded bodies is ensured. Wettability of the surface with water can be changed in a reversible manner by using the shape memory effect.

### Embodiment 1

A molded body was prepared comprising a shape memory polymer of the Tecoflex® EG-72D type (The Lubrizol Corporation). This is characterized inter alia by its advantageously low transformation temperature of approximately 40° C., which keeps the energy costs for this process very low. A part of this structured molded body attached upside down in its permanent shape to a sandblasted plate was brought into contact with oil, which was adsorbed (see FIGS. 1a+b). The surface structures were then pressed flat by means of a roller under a pressure of 50 kN, causing the surface structure to be compressed and the oil to be pressed out of this structure (see FIG. 1c). In FIG. 1d, the surface structure which was temporarily pressed flat was restored to its permanent shape by heating the sandblasted plate to just above 40° C. Oil was then reapplied and the method was repeated five times.

### Embodiment 2

Five molded bodies (specimens 1 to 5) comprising Tecoflex® EG-72D were pressed flat and restored up to ten times; the water contact angle on the restored surface of the molded bodies was measured in each case and found to be in the high hydrophobic range (>120°). By way of example, the water contact angle on the temporarily flat-pressed specimen was also measured on specimen 1 after the first, second, third, fifth, seventh and tenth flat-pressing operations, leading to measured values in the hydrophilic range (90° and lower). (n=5 measurements per data point; the error bar shows the standard deviation)

A drop (5 μl) of deionized water was placed on the surface to be tested for the purpose of static contact angle measurement by means of computer-aided drop contour analysis using an OCA 40 contact angle measuring device (Dataphysics). The image of the drop on the surface, as taken with a CCD camera, was evaluated using SCA 20 software to determine the contact angle.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A molded body comprising:
a shape memory material, wherein the molded body has a three-dimensional surface structure which, in a permanent shape, at least in part has a superhydrophobic surface and/or a hydrophobic surface, on which water droplet contact angles of 120° to 150° are found.

2: The molded body according to claim 1, wherein the molded body in a temporary shape at least in part has a superhydrophilic surface and/or a hydrophilic surface on which water droplet contact angles of less than 90° are found.

3: A method for separating at least one liquid from a molded body, the method comprising:
a) preparing a molded body comprising a shape memory material, wherein the molded body has a three-dimensional surface structure, which, in a permanent shape, at least in part has a superhydrophobic surface and/or a hydrophobic surface, on which water droplet contact angles of 120° to 150° are found;
b) establishing contact between the molded body and at least one liquid, wherein the at least one liquid will selectively adhere to the molded body;
c) transforming the surface structure into a temporary shape by flat pressing, wherein the at least in part superhydrophobic and/or hydrophobic surface is minimized;
d) removing the at least one liquid; and
e) returning the surface structure to the permanent shape.

4: The method for separating at least one liquid from a molded body according to claim 3, wherein method steps a) to e) are repeated at least once.

5: The method for separating at least one liquid from a molded body according to claim 3, wherein the shape memory material is selected from the group consisting of polymers, metal alloys, ceramics and gels.

6: The method for separating at least one liquid from a molded body according to claim 3, wherein the shape memory material is a heat-activated shape memory polymer or an elastomer or a thermoplastic elastomer.

7: The method for separating at least one liquid from a molded body according to claim 3, wherein the at least one liquid is non-polar.

8: The method for separating at least one liquid from a molded body according to claim 3, wherein the at least one liquid is oil.

9: The method for separating at least one liquid from a molded body according to claim 3, wherein the craters have an average diameter of 2 μm to 250 μm and a height of 1 μm to 500 μm, and wherein tiny polymer hairs with a length of 0.5 μm to 200 μm are formed on the upper edges of the craters.

10: The method for separating at least one liquid from a molded body according to claim 3, wherein the molded body is placed at least in part on at least one first roller, and the molded body is in contact at least in part with at least one second roller, which transforms the surface structure into the temporary shape by radial pressure.

11: The use of the method according to claim 3 for multiple separation of liquids.

12: The use of the method according to claim 11 for continuous separation of at least one liquid from a molded body.
